(19) United States
(12) Patent Application Publication
(10) Pub. No.: US 2025/0016762 A1
(43) Pub. Date: Jan. 9, 2025

(54) LAYER 1 SIGNALING FOR SIDELINK SCHEDULING

(71) Applicant: QUALCOMM Incorporated, San Diego, CA (US)

(72) Inventors: Chih-Hao LIU, San Diego, CA (US); Jing SUN, San Diego, CA (US); Xiaoxia ZHANG, San Diego, CA (US)

(21) Appl. No.: 18/347,466

(22) Filed: Jul. 5, 2023

(51) Int. Cl. H04W 72/12; H04W 72/40

(52) U.S. Cl. CPC H04W 72/12; H04W 72/40; H04W 88/04

(57) ABSTRACT

Various aspects of the present disclosure generally relate to wireless communication. In some aspects, a first user equipment (UE) may receive scheduling information for the first UE using Layer 1 (L1) signaling, the scheduling information including a first target and a first granted resource for the first UE. The UE may transmit or receive a communication on a sidelink using L1 signaling based at least in part on the scheduling information. Numerous other aspects are described.

### FIELD OF THE DISCLOSURE

Aspects of the present disclosure generally relate to wireless communication and to techniques and apparatuses for Layer 1 signaling for sidelink scheduling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first user equipment (UE). The method may include receiving scheduling information for the first UE using Layer 1 (L1) signaling, the scheduling information including a first target and a first granted resource for the first UE. The method may include transmitting or receiving a communication on a sidelink using L1 signaling based at least in part on the scheduling information.

Some aspects described herein relate to a method of wireless communication performed by a first UE. The method may include receiving, using L1 signaling, data and scheduling information that indicates a first relay target and a first granted resource for the first UE. The method may include forwarding the data to the first relay target using L1 signaling based at least in part on the scheduling information.

Some aspects described herein relate to a method of wireless communication performed by a first UE. The method may include receiving, using L1 signaling, scheduling information from a second UE that indicates a first relay target and a first granted resource for the first UE. The method may include transmitting a communication using L1 signaling based at least in part on the scheduling information.

Some aspects described herein relate to a method of wireless communication performed by a network entity. The method may include generating, for a relay UE, scheduling information that includes a first target and a first granted resource. The method may include transmitting the scheduling information to the relay UE using L1 signaling.

Some aspects described herein relate to a first UE for wireless communication. The first UE may include one or more memories and one or more processors coupled to the one or more memories. The one or more processors may be individually or collectively configured to cause the first UE to receive scheduling information for the first UE using L1 signaling, the scheduling information including a first target and a first granted resource for the first UE. The one or more processors may be individually or collectively configured to cause the first UE to transmit or receive a communication on a sidelink using L1 signaling based at least in part on the scheduling information.

Some aspects described herein relate to a first UE for wireless communication. The first UE may include one or more memories and one or more processors coupled to the one or more memories. The one or more processors may be individually or collectively configured to cause the first UE to receive, using L1 signaling, data and scheduling information that indicates a first relay target and a first granted resource for the first UE. The one or more processors may be individually or collectively configured to cause the first UE to forward the data to the first relay target using L1 signaling based at least in part on the scheduling information.

Some aspects described herein relate to a first UE for wireless communication. The first UE may include one or more memories and one or more processors coupled to the one or more memories. The one or more processors may be individually or collectively configured to cause the first UE to receive, using L1 signaling, scheduling information from a second UE that indicates a first relay target and a first granted resource for the first UE. The one or more processors may be individually or collectively configured to cause the first UE to transmit a communication using L1 signaling based at least in part on the scheduling information.

Some aspects described herein relate to a network entity for wireless communication. The network entity may include one or more memories and one or more processors coupled to the one or more memories. The one or more processors may be individually or collectively configured to cause the first UE to generate, for a relay UE, scheduling information that includes a first target and a first granted resource. The one or more processors may be individually or collectively configured to cause the first UE to transmit the scheduling information to the relay UE using L1 signaling.

Some aspects described herein relate to a non-transitory computer-readable medium that stores a set of instructions for wireless communication by a first UE. The set of instructions, when executed by one or more processors of the first UE, may cause the first UE to receive scheduling information for the first UE using L1 signaling, the scheduling information including a first target and a first granted resource for the first UE. The set of instructions, when executed by one or more processors of the first UE, may cause the first UE to transmit or receive a communication on a sidelink using L1 signaling based at least in part on the scheduling information.

Some aspects described herein relate to a non-transitory computer-readable medium that stores a set of instructions for wireless communication by a first UE. The set of instructions, when executed by one or more processors of the first UE, may cause the first UE to receive, using L1 signaling, data and scheduling information that indicates a first relay target and a first granted resource for the first UE. The set of instructions, when executed by one or more processors of the first UE, may cause the first UE to forward the data to the first relay target using L1 signaling based at least in part on the scheduling information.

Some aspects described herein relate to a non-transitory computer-readable medium that stores a set of instructions for wireless communication by a first UE. The set of instructions, when executed by one or more processors of the first UE, may cause the first UE to receive, using L1 signaling, scheduling information from a second UE that indicates a first relay target and a first granted resource for the first UE. The set of instructions, when executed by one or more processors of the first UE, may cause the first UE to transmit a communication using L1 signaling based at least in part on the scheduling information.

Some aspects described herein relate to a non-transitory computer-readable medium that stores a set of instructions for wireless communication by a network entity. The set of instructions, when executed by one or more processors of the network entity, may cause the network entity to generate, for a relay UE, scheduling information that includes a first target and a first granted resource. The set of instructions, when executed by one or more processors of the network entity, may cause the network entity to transmit the scheduling information to the relay UE using L1 signaling.

Some aspects described herein relate to an apparatus for wireless communication. The apparatus may include means for receiving scheduling information for the apparatus using L1 signaling, the scheduling information including a first target and a first granted resource for the apparatus. The apparatus may include means for transmitting or receiving a communication on a sidelink using L1 signaling based at least in part on the scheduling information.

Some aspects described herein relate to an apparatus for wireless communication. The apparatus may include means for receiving, using L1 signaling, data and scheduling information that indicates a first relay target and a first granted resource for the apparatus. The apparatus may include means for forwarding the data to the first relay target using L1 signaling based at least in part on the scheduling information.

Some aspects described herein relate to an apparatus for wireless communication. The apparatus may include means for receiving, using L1 signaling, scheduling information from another apparatus that indicates a first relay target and a first granted resource for the apparatus. The apparatus may include means for transmitting a communication using L1 signaling based at least in part on the scheduling information.

Some aspects described herein relate to an apparatus for wireless communication. The apparatus may include means for generating, for another apparatus, scheduling information that includes a first target and a first granted resource. The apparatus may include means for transmitting the scheduling information to the other apparatus using L1 signaling.

Aspects generally include a method, apparatus, system, computer program product, non-transitory computer-readable medium, UE, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications and access link communications, in accordance with the present disclosure.

FIG. 5 is a diagram illustrating an example of sidelink communications and access link communications, in accordance with the present disclosure.

FIG. 6 is a diagram illustrating an example of selecting sidelink resources, in accordance with the present disclosure.

FIG. 7 is a diagram illustrating an example of sidelink coverage, in accordance with the present disclosure.

FIG. 8 is a diagram illustrating an example of using Layer 1 (L1) signaling for sidelink relay, in accordance with the present disclosure.

FIG. 9 is a diagram illustrating an example of using L1 signaling, in accordance with the present disclosure.

FIG. 10 is a diagram illustrating an example of using L1 signaling, in accordance with the present disclosure.

FIG. 11 is a diagram illustrating an example of using L1 signaling, in accordance with the present disclosure.

FIG. 12 is a diagram illustrating an example process performed, for example, by a UE, in accordance with the present disclosure.

FIG. 13 is a diagram illustrating an example process performed, for example, by a UE, in accordance with the present disclosure.

FIG. 14 is a diagram illustrating an example process performed, for example, by a UE, in accordance with the present disclosure.

FIG. 15 is a diagram illustrating an example process performed, for example, by a network entity, in accordance with the present disclosure.

FIG. 16 is a diagram of an example apparatus for wireless communication, in accordance with the present disclosure.

FIG. 17 is a diagram of an example apparatus for wireless communication, in accordance with the present disclosure.

### DETAILED DESCRIPTION

A user equipment (UE) may be in coverage of a cell of a network entity or out of coverage. In-coverage UEs may act as relays for out-of-coverage (OOC) UEs. The relaying for OOC UEs may include sidelinks, including sidelink mode 2, where UEs schedule sidelink information. However, without the network entity controlling the sidelink relay scheduling, the UEs operate in a contention-based fashion, where there can be collisions and inefficiency. Furthermore, sidelink relay is managed by higher layers (e.g., Layer 3 (L3)). Because L3 relay signaling involves decoding and forwarding communications to upper layers, there can be a latency penalty.

According to various aspects described herein, the UEs may use L1 signaling for sidelink scheduling and data transmission. L1 signaling may involve signaling at the physical (PHY) layer or a medium access control (MAC) layer, where data and control information may be forwarded without decoding. L1 signaling delivers packets faster than using higher layer relaying. In some aspects, the network entity may transmit scheduling information on a forward link (FL) to a UE (e.g., a normal UE) or to a relay UE (single hop relay). The scheduling information may indicate target/destination UEs and resources (e.g., time/frequency resources, L1 sidelink grant) to be used by the UEs. The relay UE may forward the scheduling information to other UEs, such as to OOC UEs or further OOC UEs in multi-hop relay. In this way, the network entity may control the scheduling and quality of service (QOS) for in-coverage UEs and OOC UEs, including for multi-hop relaying, reverse link (RL) transmissions back to the network entity via sidelink relaying, and/or OOC initial access. As a result, the sidelink relaying avoids collisions and reduces latency.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

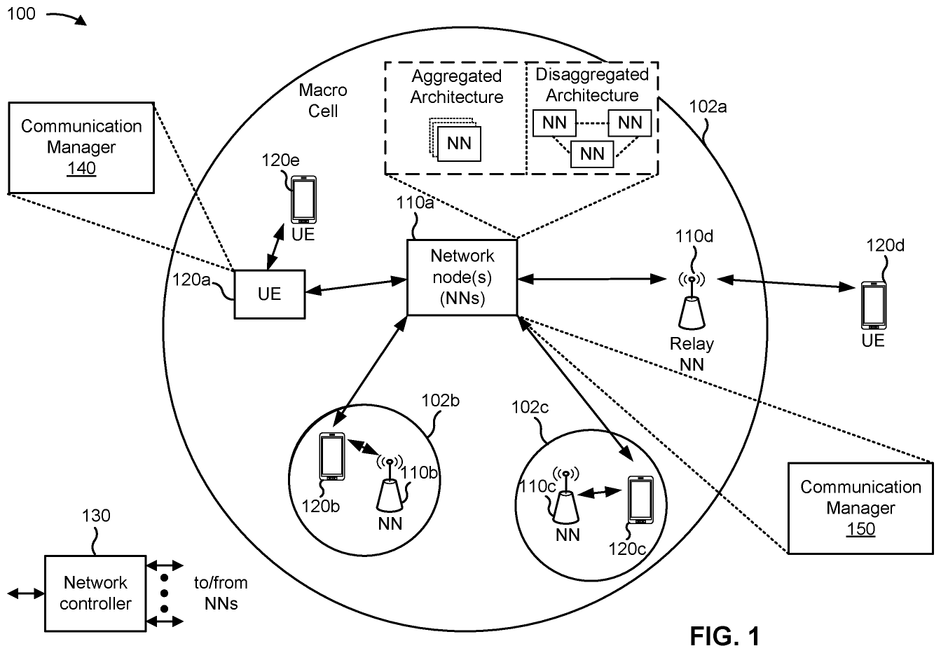

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., a UE 120) may include a communication manager 140. As described in more detail elsewhere herein, the communication manager 140 may receive scheduling information for the first UE using L1 signaling, the scheduling information including a first target and a first granted resource for the first UE. The communication manager 140 may transmit or receive a communication on a sidelink using L1 signaling based at least in part on the scheduling information.

In some aspects, the communication manager 140 may receive, using L1 signaling, data and scheduling information that indicates a first relay target and a first granted resource for the first UE. The communication manager 140 may forward the data to the first relay target using L1 signaling based at least in part on the scheduling information.

In some aspects, the communication manager 140 may receive, using L1 signaling, scheduling information from a second UE that indicates a first relay target and a first granted resource for the first UE. The communication manager 140 may transmit a communication using L1 signaling based at least in part on the scheduling information. Additionally, or alternatively, the communication manager 140 may perform one or more other operations described herein.

In some aspects, a network entity (e.g., a network node 110) may include a communication manager 150. As described in more detail elsewhere herein, the communication manager 150 may generate, for a relay UE, scheduling information that includes a first target and a first granted resource. The communication manager 150 may transmit the scheduling information to the relay UE using L1 signaling. Additionally, or alternatively, the communication manager 150 may perform one or more other operations described herein.

As indicated above, FIG. 1 is provided as an example. Other examples may differ from what is described with regard to FIG. 1.

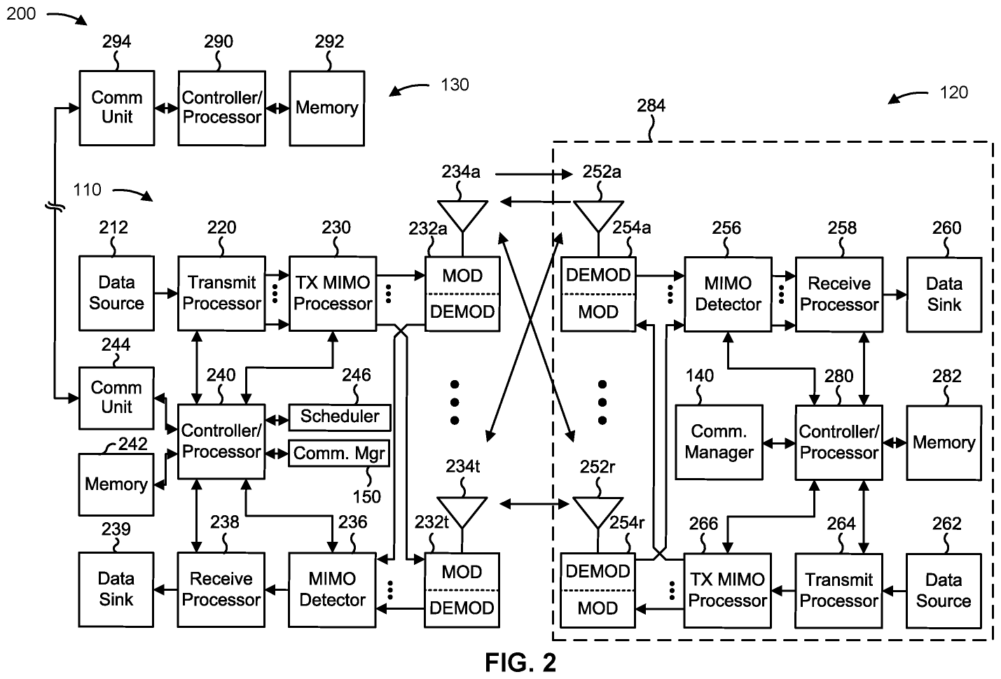

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

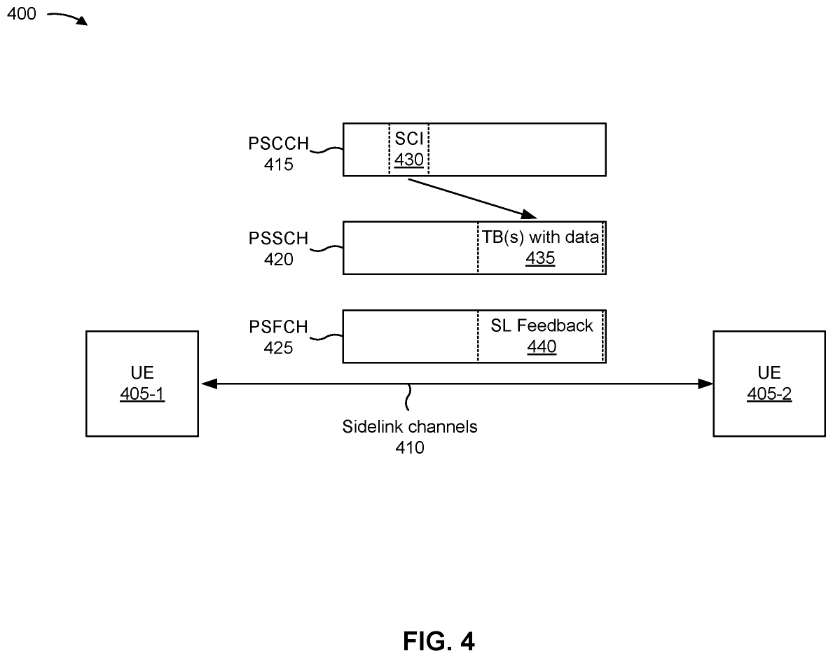

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-17).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-17).

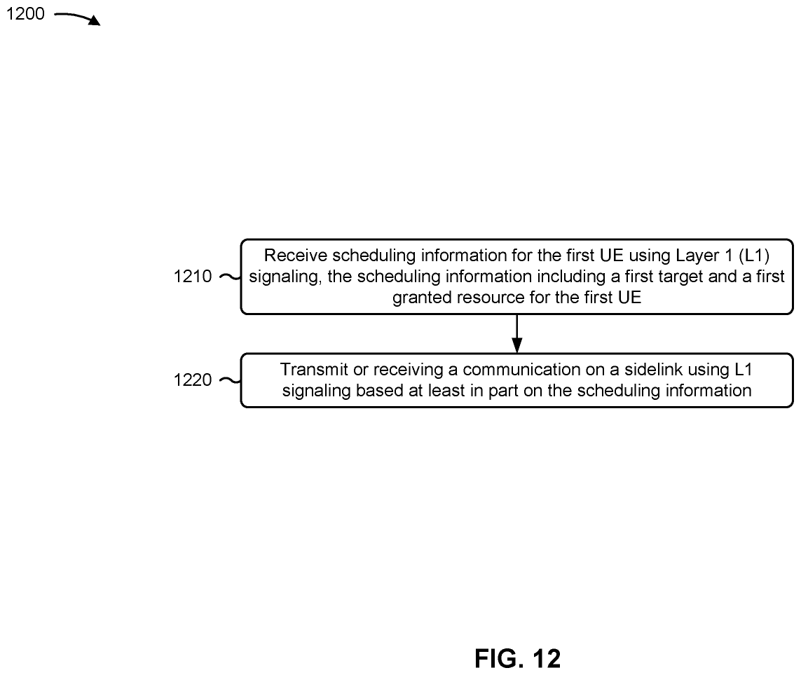

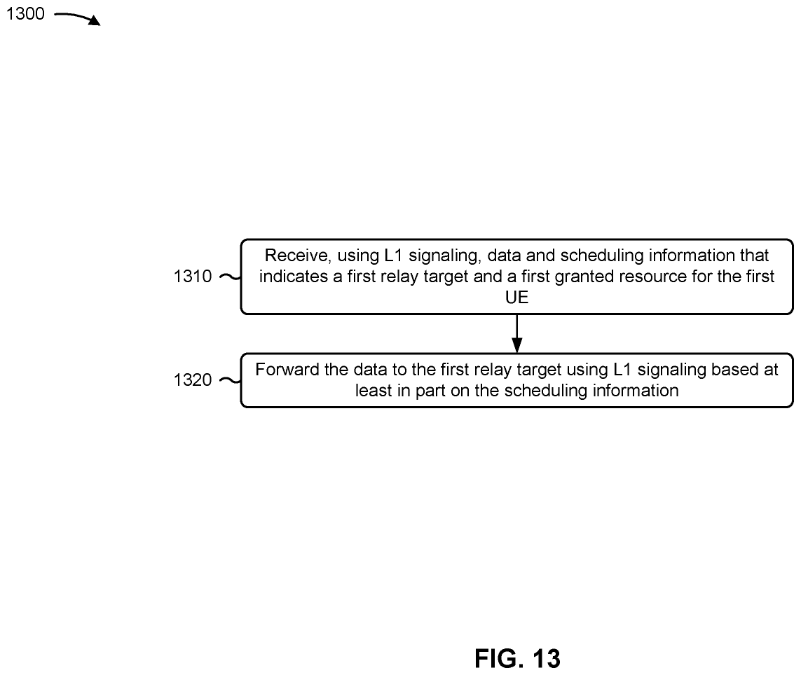

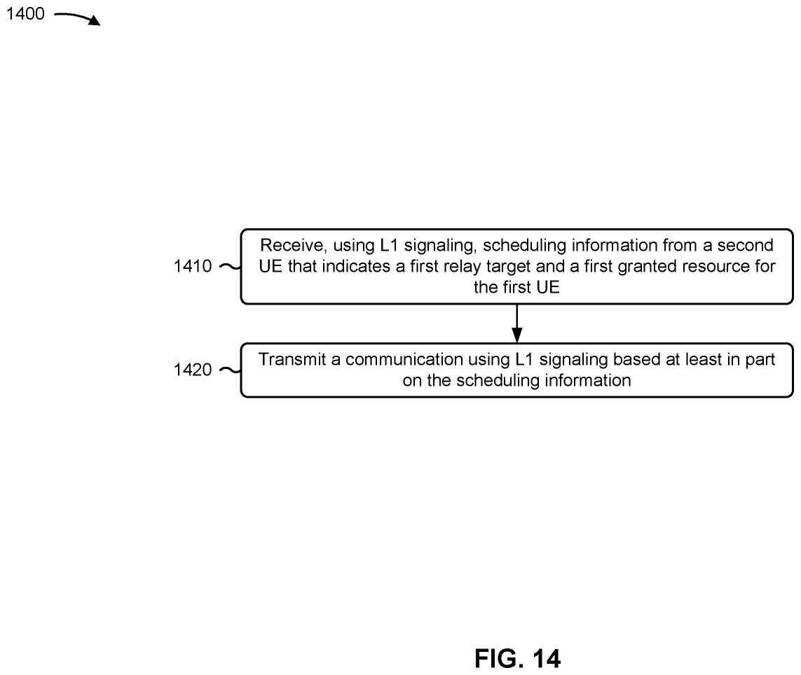

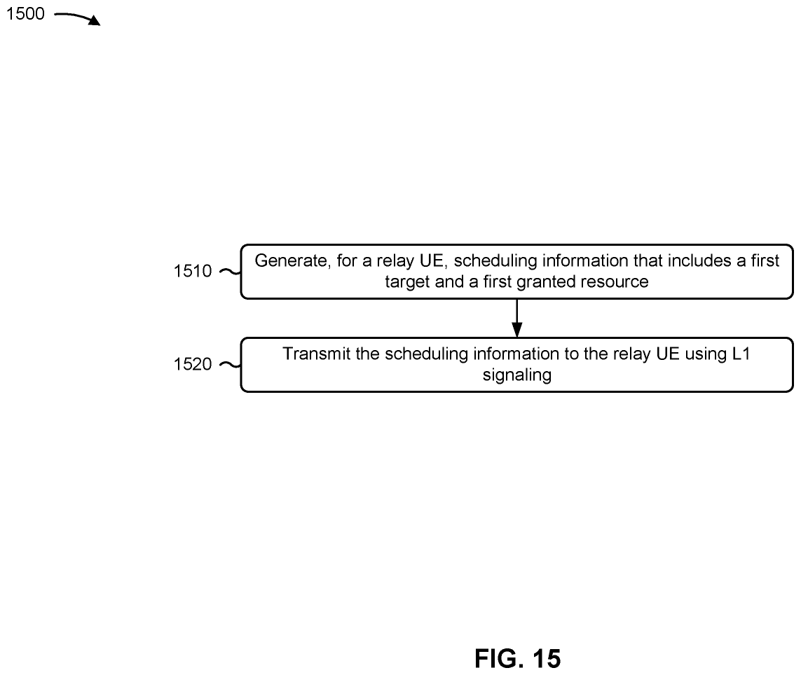

A controller/processor of a network entity (e.g., a controller/processor 240 of the network node 110), the controller/processor 280 of the UE 120, and/or any other component(s) of FIG. 2 may perform one or more techniques associated with L1 signaling for sidelink scheduling, as described in more detail elsewhere herein. In some aspects, the controller/processor 240 of the network node 110, the controller/processor 280 of the UE 120, and/or any other component(s) of FIG. 2 may perform or direct operations of, in some aspects, process 1200 of FIG. 12, process 1300 of FIG. 13, process 1400 of FIG. 14, process 1500 of FIG. 15, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. In some aspects, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, in some aspects, process 1200 of FIG. 12, process 1300 of FIG. 13, process 1400 of FIG. 14, process 1500 of FIG. 15, and/or other processes as described herein. In some examples, executing instructions may include running the instructions, converting the instructions, compiling the instructions, and/or interpreting the instructions, among other examples.

In some aspects, a first UE (e.g., a UE 120) includes means for receiving scheduling information for the first UE using L1 signaling, the scheduling information including a first target and a first granted resource for the first UE; and/or means for transmitting or receiving a communication on a sidelink using L1 signaling based at least in part on the scheduling information. The means for the first UE to perform operations described herein may include, in some aspects, one or more of communication manager 140, antenna 252, modem 254, MIMO detector 256, receive processor 258, transmit processor 264, TX MIMO processor 266, controller/processor 280, or memory 282.

In some aspects, the first UE includes means for receiving, using L1 signaling, data and scheduling information that indicates a first relay target and a first granted resource for the first UE; and/or means for forwarding the data to the first relay target using L1 signaling based at least in part on the scheduling information.

In some aspects, the first UE includes means for receiving, using L1 signaling, scheduling information from a second UE that indicates a first relay target and a first granted resource for the first UE; and/or means for transmitting a communication using L1 signaling based at least in part on the scheduling information.

In some aspects, a network entity (e.g., a network node 110) includes means for generating, for a relay UE, scheduling information that includes a first target and a first granted resource; and/or means for transmitting the scheduling information to the relay UE using L1 signaling. In some aspects, the means for the network entity to perform operations described herein may include, in some aspects, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. In some aspects, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. In some aspects, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. In some aspects, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. In some aspects, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. In some aspects, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

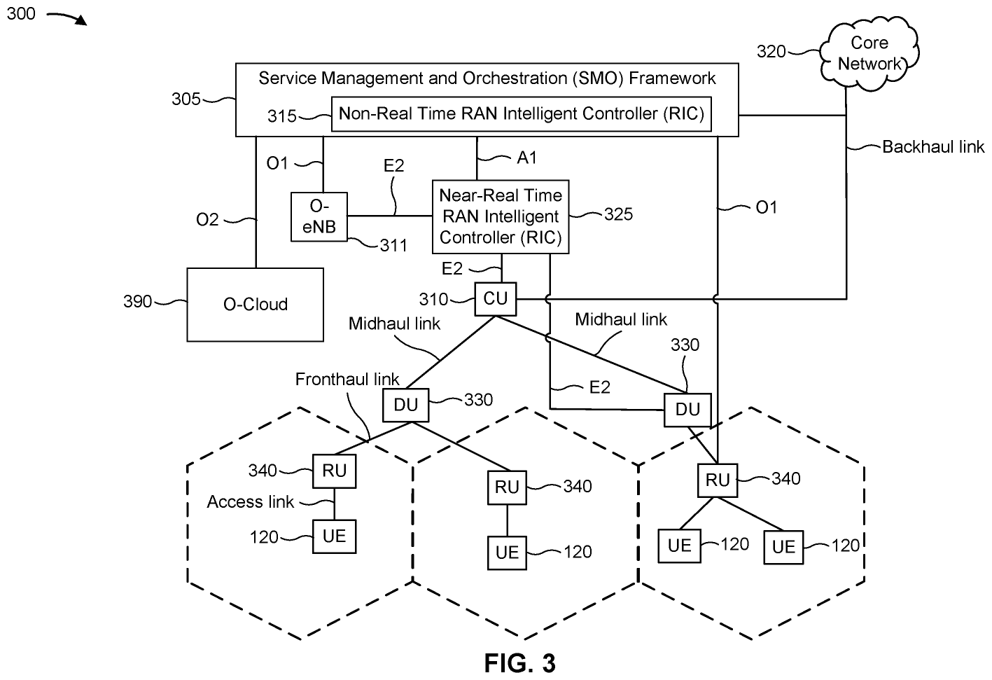

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. In some aspects, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, in some aspects, an indication of one or more resources (e.g., time resources, frequency resources, and/or spatial resources) on the PSSCH 420, information for decoding sidelink communications on the PSSCH, a QoS priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as a hybrid automatic repeat request (HARQ) process ID, a new data indicator (NDI), a source identifier, a destination identifier, and/or a channel state information (CSI) report trigger.

In some aspects, the one or more sidelink channels 410 may use resource pools. In some aspects, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). In some aspects, the UE 405 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. In some aspects, the UE 405 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, in some aspects, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or a modulation and coding scheme (MCS) to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

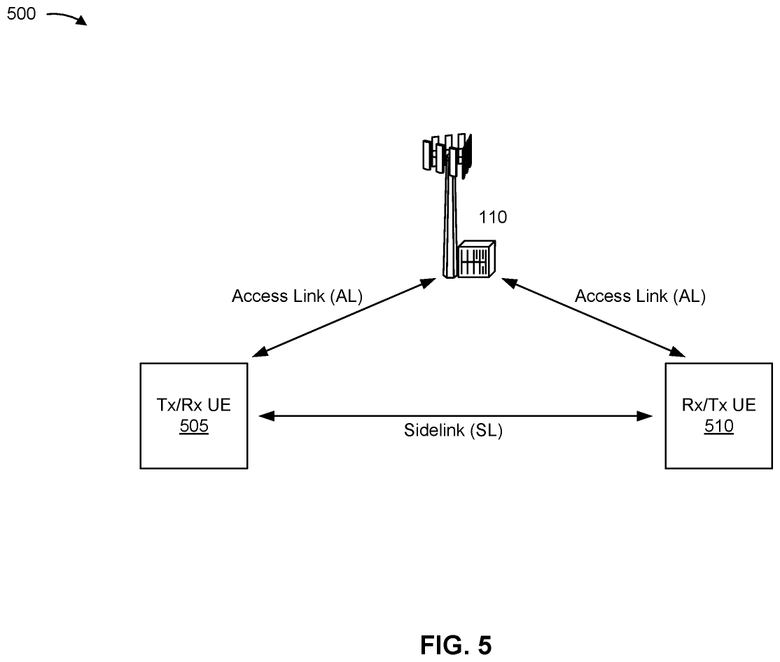

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 3. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 5 is provided as an example. Other examples may differ from what is described with respect to FIG. 5.

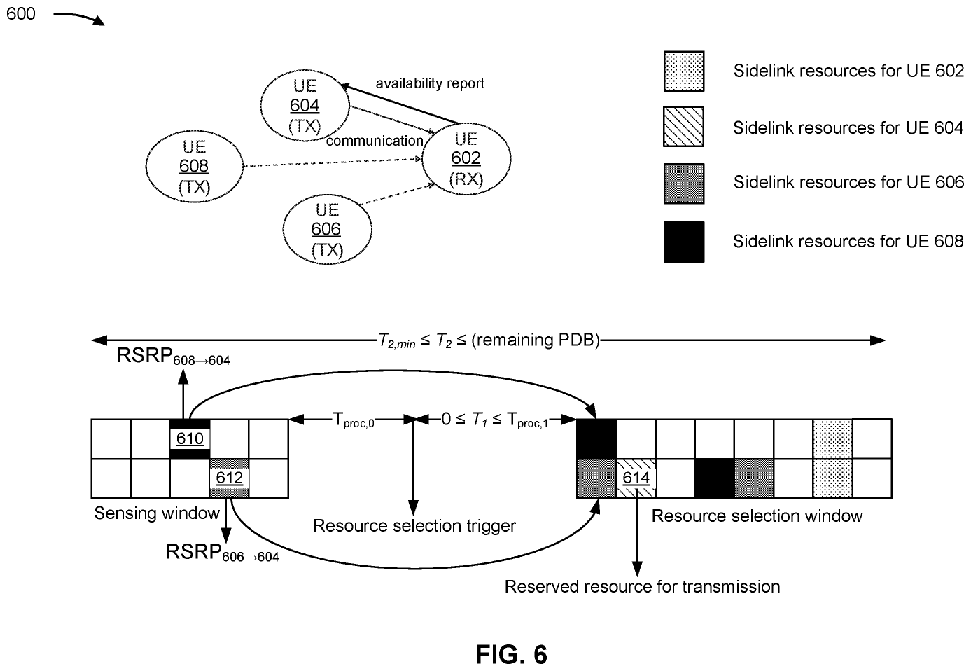

FIG. 6 is a diagram illustrating an example 600 of selecting sidelink resources, in accordance with the present disclosure. Example 600 shows a UE 602 (e.g., a UE 120) that may receive communications on a sidelink channel from other UEs, such as UE 604, UE 606, and/or UE 608.

As described in connection with FIG. 6, UE 604 is a transmitting UE that is transmitting communications to UE 602, which is a receiving UE. UE 604 may use a report from UE 602, which may act as a reporting UE that reports available sidelink resources, preferred sidelink resources, non-preferred sidelink resources, or sidelink resource conflicts. Example 600 shows an availability report from UE 602 to UE 604 and a communication from UE 604 to UE 602.

If UE 604 is to transmit a communication to UE 602, UE 604 may sense the sidelink channel in a sensing window to determine which sidelink resources (e.g., subcarriers, subchannels) are available. UE 604 may use a listen-before-talk (LBT) procedure to sense the channel. The LBT procedure maybe a Type 1 LBT procedure, where UE 604 listens for multiple slots (e.g., 9 milliseconds (ms)) and uses a counter. A sidelink resource may be considered available if the sidelink resource was clear or had a signal energy (e.g., RSRP) that satisfied an availability threshold (e.g., measured interference or energy on the channel is lower than a maximum decibel-milliwatts (dBm) or dB, RSRP threshold). The availability threshold may be configured or preconfigured per transmission priority and receive priority pair. UE 604 may measure DMRSs on a PSCCH or a PSSCH, according to a configuration.

In some aspects, UE 604 may prepare to transmit a communication to UE 602. UE 604 may have already sensed previous sidelink resources and successfully decoded SCI from UE 606 and UE 608. UE 604 may try to reserve sidelink resources, and thus may check the availability of the future sidelink resources reserved by UE 606 and UE 608 by sensing the sidelink channel in the sensing window. UE 604 may measure an RSRP of a signal from UE 608 in sidelink resource 610, and an RSRP of a signal from UE 606 in sidelink resource 612. If an observed RSRP (RSRP projection) satisfies the RSRP threshold (e.g., is lower than a maximum RSRP), the corresponding sidelink resource may be available for reservations by UE 604. UE 604 may reserve the sidelink resource (which may be a random selection from available resources). In some aspects, UE 604 may select and reserve sidelink resource 614 for transmission. This may be in a time slot after which UE 606 and UE 608 had used sidelink resources, and UE 604 may have sensed these sidelink resources earlier. UE 604 may select and reserve sidelink resources only upon reaching a threshold level (e.g., 20%, 30%, or 50% availability). UE 604 may increase or decrease the RSRP threshold as necessary to arrive at the threshold level. UE 604 may select and reserve sidelink resources in the current slot and up to two (or more) future slots. Reservations may be aperiodic or periodic (e.g., SCI signals period between 0 ms and 1000 ms). Periodic resource reservation may be disabled.

There may be a resource selection trigger to trigger selection of sidelink resources after a processing time T_{proc,0}, and before another processing time T_{proc,1} before a resource selection window from which sidelink resources are available. The resource selection window may be a time window from which sidelink resources May be selected, and the resource selection window may extend for a remaining packet delay budget (PDB).

As indicated above, FIG. 6 is provided as an example. Other examples may differ from what is described with regard to FIG. 6.

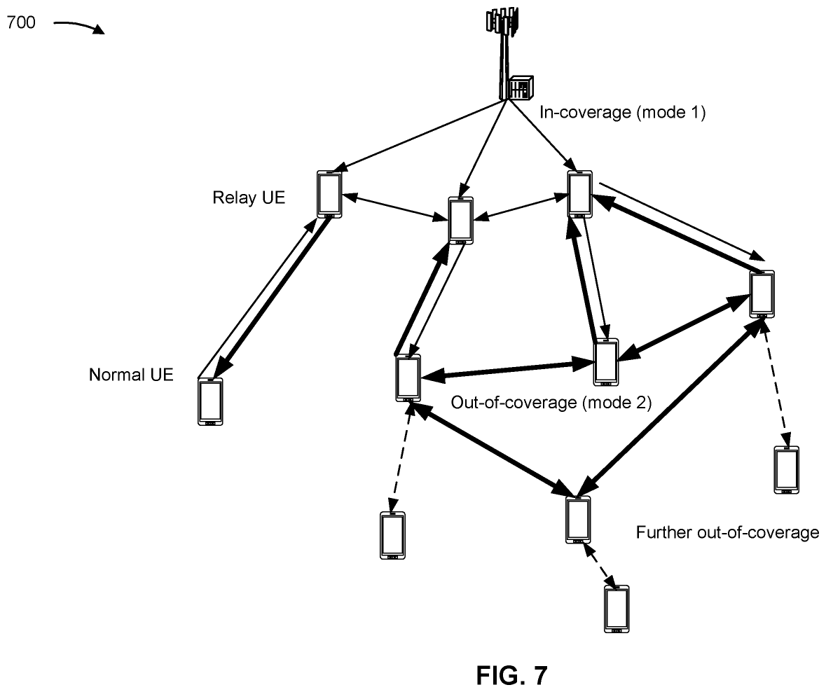

FIG. 7 is a diagram illustrating an example 700 of sidelink coverage, in accordance with the present disclosure.

Example 700 shows in-coverage UEs and OOC UEs (bold arrows). In NR sidelink mode 1, a network entity may have some control over sidelink, but the control is for in-coverage UEs only (mode 1). The sidelink scheduling may be sent to a UE through DCI 3_0.

For OOC UEs, sidelink mode 2 can be used. However, without the network entity controlling the sidelink relay scheduling, the UEs operate in a contention-based fashion, where there can be collisions and inefficiency. Furthermore, sidelink relay is managed by higher layers (e.g., L3). Because L3 relay signaling involves decoding and forwarding communications to upper layers, there can be a latency penalty.

According to various aspects described herein, the UEs may use L1 signaling for sidelink scheduling and data transmission. L1 signaling may involve signaling at the PHY layer or a MAC layer, where data and control information may be forwarded without decoding. L1 signaling delivers packets faster than using higher layer relaying. In some aspects, the network entity may transmit scheduling information on an FL to a UE (e.g., a normal UE) or to a relay UE (single hop relay). The scheduling information may indicate target/destination UEs and resources (e.g., time/frequency resources, L1 sidelink grant) to be used by the UEs. The relay UE may forward the scheduling information to other UEs, such as to OOC UEs or further OOC UEs in multi-hop relay, as shown in example 700. In this way, the network entity may control the scheduling and QoS for in-coverage UEs and OOC UEs, including for multi-hop relaying, RL transmissions back to the network entity via sidelink relaying, and/or OOC initial access. As a result, the sidelink relaying avoids collisions and reduces latency. The scheduling information may provide more control than signal repeaters.

In some aspects, the scheduling information may be for relaying Uu traffic. The network entity may use L1 signaling to control how to relay the FL traffic through the relaying UE via PC-5 toward a target UE. The network entity may also use L1 signaling to control how to relay the RL traffic through the relaying UE (via sidelink) to the network entity.

A UE that receives scheduling information and that is not a relay UE or does not forward a communication may be referred to as a “normal UE.” A normal UE may not be able to see the network entity and a relay UE. A low-end UE may not take advantage of a relay UE and thus can be an OOC UE, even when the coverage is provided by a relay UE. A high-end UE may take advantage of a relay UE and thus have better throughput and coverage.

As indicated above, FIG. 7 is provided as an example. Other examples may differ from what is described with regard to FIG. 7.

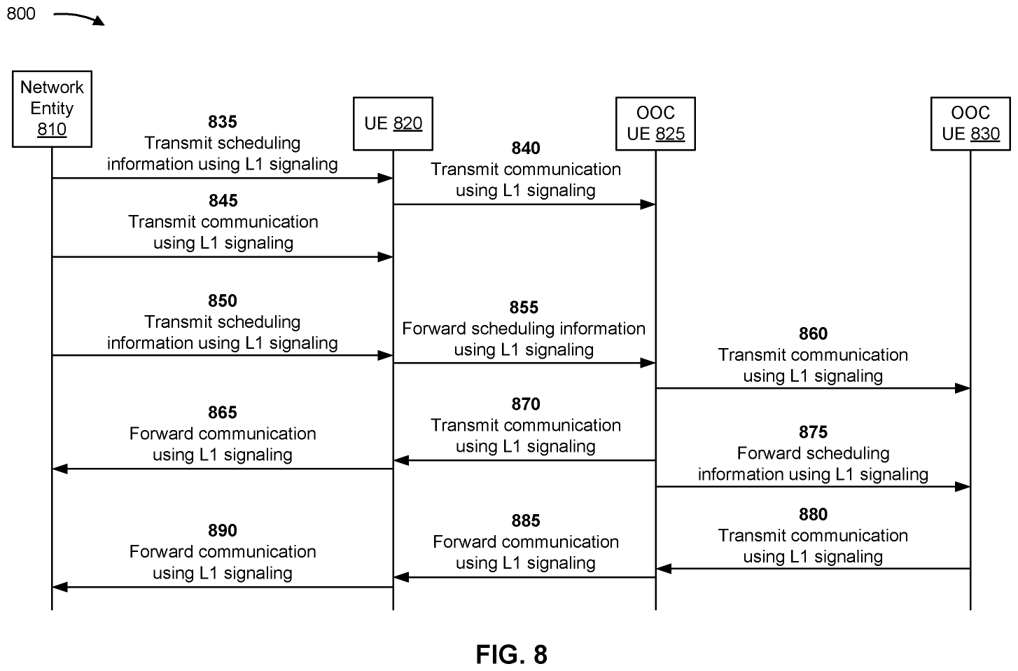

FIG. 8 is a diagram illustrating an example 800 of using of L1 signaling for sidelink relay, in accordance with the present disclosure.

Example 800 shows a network entity 810 (e.g., network node 110) that may communicate with a UE 820 (e.g., UE 120) in a wireless network (e.g., wireless network 100). UE 820 may communicate with OOC UE 825 (e.g., UE 120) over a sidelink. OOC UE 825 may communicate with OOC UE 830 over a sidelink.

In some aspects, the network entity 810 may transmit an L1 sidelink grant (for a normal UE) that indicates, to a target transmit UE (the UE transmitting the data), with which UE the transmit UE is to communicate. The L1 sidelink grant may also indicate the resources to be used for the L1 signaling.

In some aspects, the network entity 810 may use L1 relay signaling (for a relay UE) that instructs the relay UE where the L1 sidelink grant/RL grant is be sent or where a relayed packet for FL/RL is to be sent across L1 relay(s) toward the target UE/network entity. The network entity 810 may control sidelink communications of UEs with L1 signaling (more control than sidelink mode 1 operation). In some aspects, L1 relay signaling may include an L1 RL grant (for a high-end normal UE) that indicates scheduling resources for the RL transmit UE and multi-hop relay signaling information for relaying an RL packet back to the network entity. The RL transmit UE may transmit L1 relay signaling with the RL packet.

Example 800 shows L1 signaling with UE 820 acting as a normal UE (not a relay UE). As shown by reference number 835, the network entity 810 may transmit scheduling information using L1 signaling. As shown by reference number 840, UE 820 may use the scheduling information to transmit a communication using L1 signaling. As shown by reference number 845, UE 820 may use the scheduling information to receive a communication using L1 signaling.

Example 800 also shows L1 signaling with UE 820 acting as a relay UE. As shown by reference number 850, the network entity 810 may transmit scheduling information using L1 signaling. The scheduling information may include relay information for relaying data and control information. As shown by reference number 855, UE 820 may forward the scheduling information to OOC UE 825 using L1 signaling. As shown by reference number 860, OOC UE 825 may use the scheduling information to transmit a communication to OOC UE 830 using L1 signaling.

Example 800 shows L1 signaling for RL communications. The scheduling information may include RL information for transmission back to the network entity 810. As shown by reference number 870, OOC UE 825 may use the scheduling information to transmit a communication to UE 820 using L1 signaling. As shown by reference number 865, UE 820 may use the scheduling information to forward the communication to the network entity 810 using L1 signaling.

Example 800 shows L1 signaling for multi-hop relay to other in-coverage UEs or OOC UEs, such as to OOC UE 830. The scheduling information may include relay information for one or more targets (e.g., transmitting UEs, receiving UEs, network entities). The relay information may include granted resources to be used (e.g., time and frequency resources, which hops to use). As shown by reference number 875, 00C 825 may forward the scheduling information (received from UE 820) to OOC UE 830 (using L1 signaling). The scheduling information may include RL information. As shown by reference number 880, OOC UE 830 may use the RL information to transmit a communication using L1 signaling. As shown by reference number 885, OOC UE 825 may use the RL information to forward the communication using L1 signaling. As shown by reference number 890, UE 820 may use the RL information to forward the communication to the network entity 810 using L1 signaling. By using L1 signaling, packets may be forwarded faster, which reduces latency. The network entity 810 may also have more control of sidelink communications.

As indicated above, FIG. 8 is provided as an example. Other examples may differ from what is described with regard to FIG. 8.

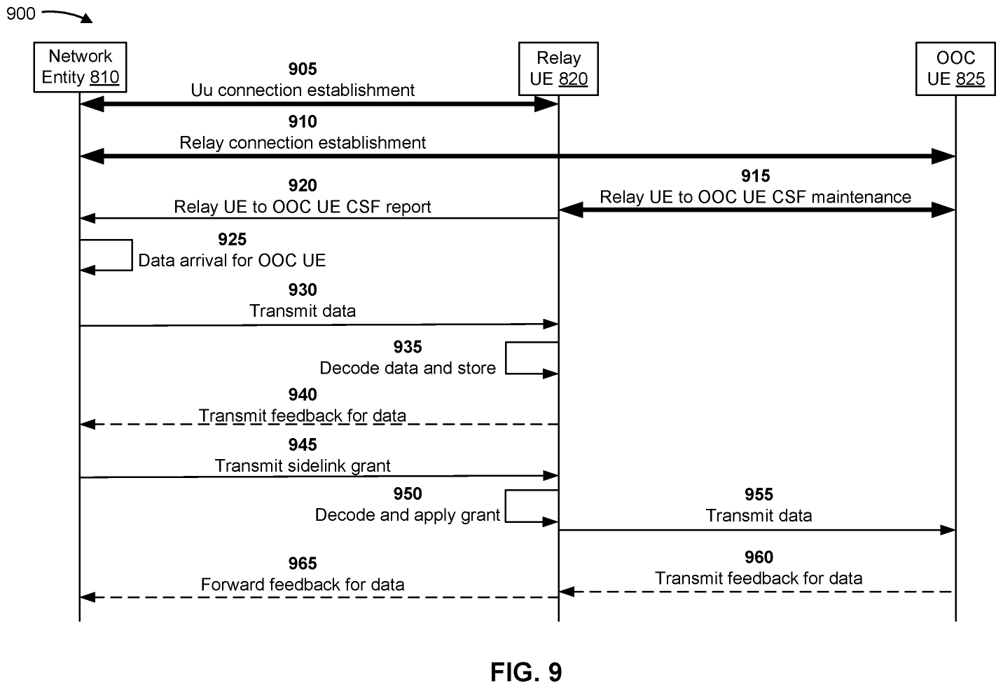

FIG. 9 is a diagram illustrating an example 900 of using L1 signaling, in accordance with the present disclosure. As shown by reference number 905, the network entity 810 and UE 820 may establish a Uu connection. In example 900, UE 820 may be a relay UE. As shown by reference number 910, the network entity 810, UE 820, and OOC 825 may establish a relay connection. As shown by reference number 915, relay UE 820 and OOC UE 825 may perform channel state feedback (CSF) maintenance for providing feedback for received communications. As shown by reference number 920, relay UE 820 may provide a CSF report.

In some aspects, the network entity 810 may transmit data for a single-hop relay or a multi-hop relay using scheduling information that is distributed to the UEs. The scheduling information may be for an FL. As shown by reference number 925, data arrives at the L1 for OOC UE 825 from upper layers. The network entity 810 may instruct relay UE 820 (using L1 signaling) to hold data for forwarding. As shown by reference number 930, the network entity 810 may transmit the data to relay UE 820 using L1 signaling. As shown by reference number 935, relay UE 820 may decode the data and store the data. This data is held for L1 relay, where the data is not forwarded to upper layers and remains at L1. As shown by reference number 940, relay UE 820 may transmit feedback (e.g., an acknowledgement (ACK)) for the data using L1 signaling.

As shown by reference number 945, the network entity 810 may transmit a sidelink grant using L1 signaling. As shown by reference number 950, relay UE 820 may decode and apply the sidelink grant. This may include preparing to use the resources of the sidelink grant. As shown by reference number 955, relay UE 820 may transmit the data to OOC UE 825 using L1 signaling. As shown by reference number 960, OOC UE 825 may transmit feedback for the data using L1 signaling. As shown by reference number 965, relay UE 820 may forward the feedback using L1 signaling.

As indicated above, FIG. 9 is provided as an example. Other examples may differ from what is described with regard to FIG. 9.

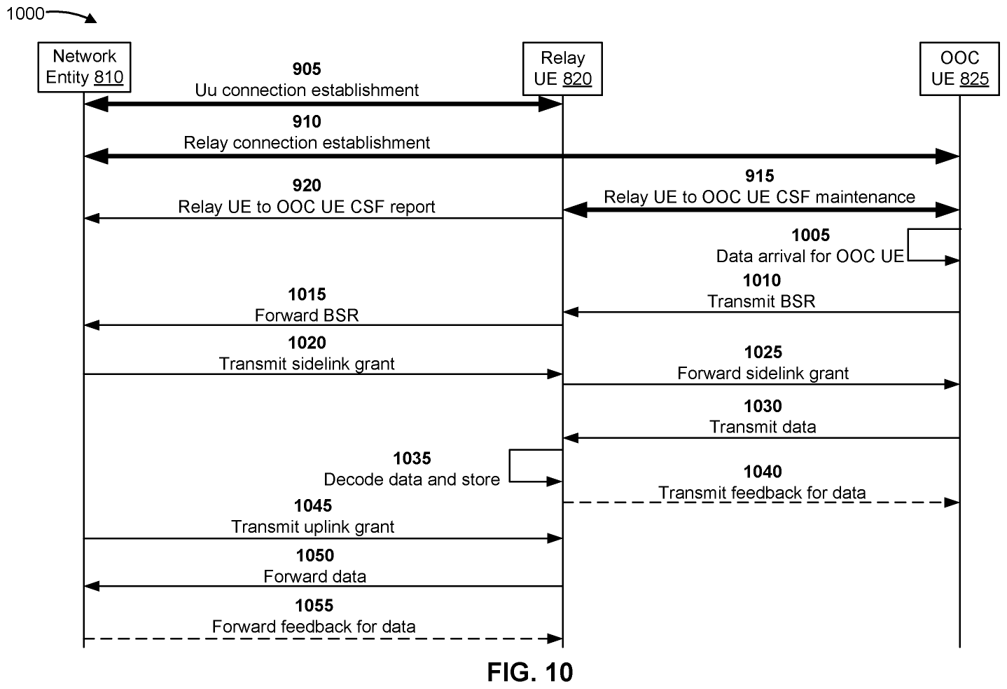

FIG. 10 is a diagram illustrating an example 1000 of using L1 signaling, in accordance with the present disclosure. In example 1000, UE 820 may be a relay UE. The L1 signaling may be for an RL.

In some aspects, OOC 825 may use L1 signaling to transmit a buffer status report (BSR) to obtain a sidelink grant for relaying. The relaying may be to another UE that may be an in-coverage UE or another OOC UE. The other UE in example 1000 is relay UE 820. As shown by reference number 1005, data may arrive from a higher layer for OOC UE 825. As shown by reference number 1010, OOC UE 825 may transmit a BSR. As shown by reference number 1015, relay UE 820 may forward the BSR. As shown by reference number 1020, the network entity 810 may transmit a sidelink grant that is based at least in part on the BSR. As shown by reference number 1025, relay UE 820 may forward the sidelink grant. As shown by reference number 1030, OOC UE 825 may transmit data. As shown by reference number 1035, relay UE 820 may decode and store the data. As shown by reference number 1040, relay UE 820 may transmit feedback for the data. As shown by reference number 1045, the network entity 810 may transmit an uplink grant for forwarding the data to the network entity 810. As shown by reference number 1050, relay UE 820 may forward the data. As shown by reference number 1055, the network entity 810 may transmit feedback for the data.

As indicated above, FIG. 10 is provided as an example. Other examples may differ from what is described with regard to FIG. 10.

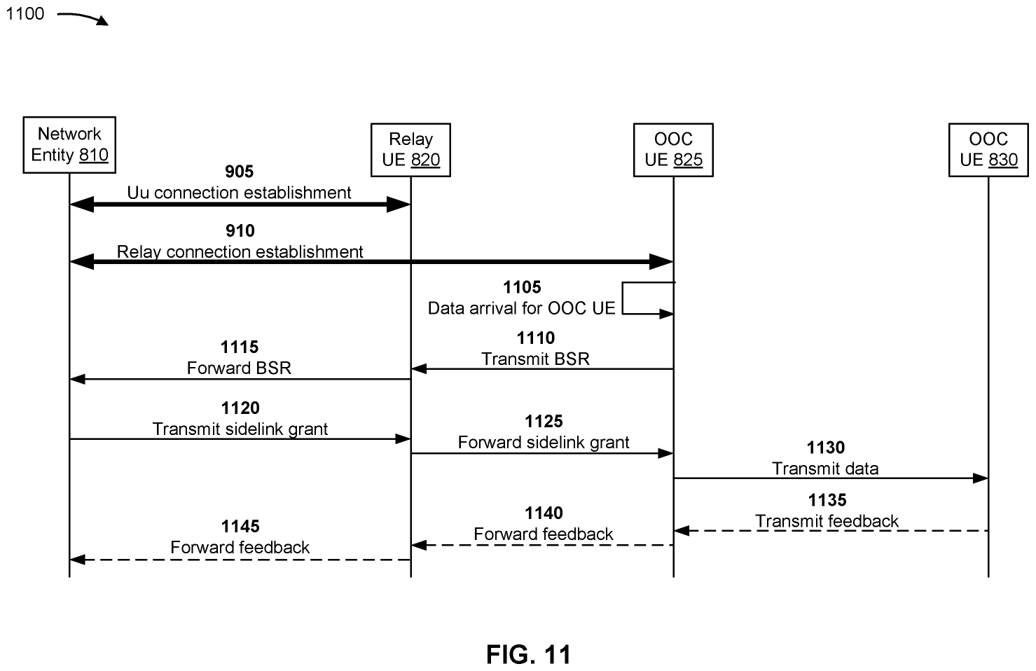

FIG. 11 is a diagram illustrating an example 1100 of using L1 signaling, in accordance with the present disclosure. In example 1100, UE 820 may be a relay UE. The L1 signaling may be for another UE as part of multiple sidelink hops, such as for OOC UE 825.

As shown by reference number 1105, data may arrive at OOC UE 825 from upper layers. As shown by reference number 1110, OOC UE 825 may transmit a BSR. As shown by reference number 1115, relay UE 820 may forward the BSR to the network entity 810.

As shown by reference number 1120, the network entity 810 may transmit a sidelink grant based at least in part on the BSR. As shown by reference number 1125, relay UE 820 may forward the sidelink grant. As shown by reference number 1130, OOC UE 825 may transmit data to OOC UE 830. As shown by reference number 1135, OOC UE 830 may transmit feedback for the data. As shown by reference number 1140, OOC UE 825 may forward the feedback. As shown by reference number 1145, relay UE 820 may forward the feedback.

As indicated above, FIG. 11 is provided as an example. Other examples may differ from what is described with regard to FIG. 11.

The foregoing disclosure provides illustration and description but is not intended to be exhaustive or to limit the aspects to the precise forms disclosed. Modifications and variations may be made in light of the above disclosure or may be acquired from practice of the aspects.

FIG. 12 is a diagram illustrating an example process 1200 performed, in some aspects, by a UE, in accordance with the present disclosure. Example process 1200 is an example where the UE (e.g., UE 120, UE 820, UE 825) performs operations associated with L1 signaling for sidelink scheduling.

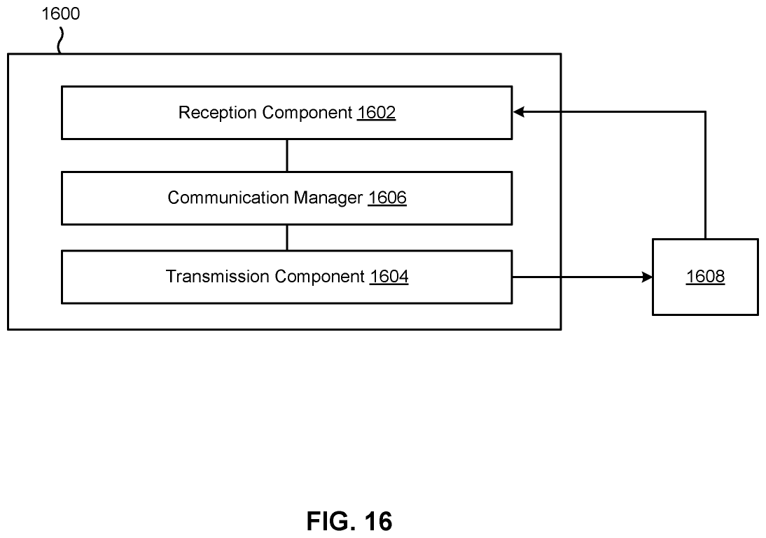

As shown in FIG. 12, in some aspects, process 1200 may include receiving scheduling information for the first UE using L1 signaling, the scheduling information including a first target and a first granted resource for the first UE (block 1210). In some aspects, the UE (e.g., using reception component 1602 and/or communication manager 1606, depicted in FIG. 16) may receive scheduling information for the first UE using L1 signaling, the scheduling information including a first target and a first granted resource for the first UE, as described above.

As further shown in FIG. 12, in some aspects, process 1200 may include transmitting or receiving a communication on a sidelink using L1 signaling based at least in part on the scheduling information (block 1220). In some aspects, the UE (e.g., using transmission component 1604 and/or communication manager 1606, depicted in FIG. 16) may transmit or receive a communication on a sidelink using L1 signaling based at least in part on the scheduling information, as described above.

Process 1200 may include additional aspects, such as any single aspect or any combination of aspects described below and/or in connection with one or more other processes described elsewhere herein.

In a first aspect, the first UE is a relay UE, the scheduling information includes relay information for one or more other targets and one or more granted resources associated with the one or more other targets, and process 1200 includes transmitting the scheduling information using L1 signaling to a second UE that is one of the one or more targets.

In a second aspect, alone or in combination with the first aspect, receiving the scheduling information includes receiving the scheduling information from another relay UE using L1 signaling.

In a third aspect, alone or in combination with one or more of the first and second aspects, the scheduling information includes RL information that indicates a resource for transmission to a network entity.

In a fourth aspect, alone or in combination with one or more of the first through third aspects, receiving the scheduling information includes receiving the scheduling information from a network entity using L1 signaling.

In a fifth aspect, alone or in combination with one or more of the first through fourth aspects, receiving the scheduling information includes receiving the scheduling information from a relay UE using L1 signaling.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, in some aspects, by a UE, in accordance with the present disclosure. Example process 1300 is an example where the UE (e.g., UE 120, UE 820, UE 825) performs operations associated with L1 signaling for sidelink scheduling.

As shown in FIG. 13, in some aspects, process 1300 may include receiving, using L1 signaling, data and scheduling information that indicates a first relay target and a first granted resource for the first UE (block 1310). In some aspects, the UE (e.g., using reception component 1602 and/or communication manager 1606, depicted in FIG. 16) may receive, using L1 signaling, data and scheduling information that indicates a first relay target and a first granted resource for the first UE, as described above.

As further shown in FIG. 13, in some aspects, process 1300 may include forwarding the data to the first relay target using L1 signaling based at least in part on the scheduling information (block 1320). In some aspects, the UE (e.g., using communication manager 1606, depicted in FIG. 16) may forward the data to the first relay target using L1 signaling based at least in part on the scheduling information, as described above.

Process 1300 may include additional aspects, such as any single aspect or any combination of aspects described below and/or in connection with one or more other processes described elsewhere herein.

In a first aspect, process 1300 includes holding the data before forwarding the data based at least in part on the scheduling information.

In a second aspect, alone or in combination with the first aspect, the scheduling information includes relay information for one or more other targets and one or more granted resources associated with the one or more other targets.

In a third aspect, alone or in combination with one or more of the first and second aspects, the scheduling information includes RL information that indicates a resource for transmission to a network entity, and process 1300 includes transmitting data or feedback to the network entity using L1 signaling based at least in part on the RL information.

In a fourth aspect, alone or in combination with one or more of the first through third aspects, the scheduling information includes RL information that indicates a relay information for transmission to a network entity via the first UE, and process 1300 includes transmitting a BSR to the network entity using L1 signaling based at least in part on the RL information.

In a fifth aspect, alone or in combination with one or more of the first through fourth aspects, process 1300 includes transmitting, to a second UE using L1 signaling, a sidelink grant for transmission of a BSR from the second UE to a network entity via the first UE.

In a sixth aspect, alone or in combination with one or more of the first through fifth aspects, process 1300 includes receiving the BSR using L1 signaling, and forwarding the BSR to the network entity using L1 signaling.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, in some aspects, by a UE, in accordance with the present disclosure. Example process 1400 is an example where the UE (e.g., UE 120, UE 820, UE 825) performs operations associated with L1 signaling for sidelink scheduling.

As shown in FIG. 14, in some aspects, process 1400 may include receiving, using L1 signaling, scheduling information from a second UE that indicates a first relay target and a first granted resource for the first UE (block 1410). In some aspects, the UE (e.g., using reception component 1602 and/or communication manager 1606, depicted in FIG. 16) may receive, using L1 signaling, scheduling information from a second UE that indicates a first relay target and a first granted resource for the first UE, as described above.

As further shown in FIG. 14, in some aspects, process 1400 may include transmitting a communication using L1 signaling based at least in part on the scheduling information (block 1420). In some aspects, the UE (e.g., using transmission component 1604 and/or communication manager 1606, depicted in FIG. 16) may transmit a communication using L1 signaling based at least in part on the scheduling information, as described above.

Process 1400 may include additional aspects, such as any single aspect or any combination of aspects described below and/or in connection with one or more other processes described elsewhere herein.

In a first aspect, the first relay target is a third UE, and transmitting the communication includes transmitting data to the third UE using L1 signaling.

In a second aspect, alone or in combination with the first aspect, the scheduling information includes RL information that indicates a resource for transmission to a network entity, and process 1400 includes receiving feedback for the data from the third UE using L1 signaling, and forwarding the feedback to the network entity via the second UE using L1 signaling based at least in part on the reverse link information.

In a third aspect, alone or in combination with one or more of the first and second aspects, process 1400 includes transmitting a sidelink grant to a third UE using L1 signaling based at least in part on the scheduling information.

In a fourth aspect, alone or in combination with one or more of the first through third aspects, the scheduling information includes RL information that indicates a resource for transmission to a network entity, and process 1400 includes transmitting a BSR to a network entity using L1 signaling.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, in some aspects, by a network entity, in accordance with the present disclosure. Example process 1500 is an example where the network entity (e.g., network node 110, network entity 810) performs operations associated with L1 signaling for sidelink scheduling.

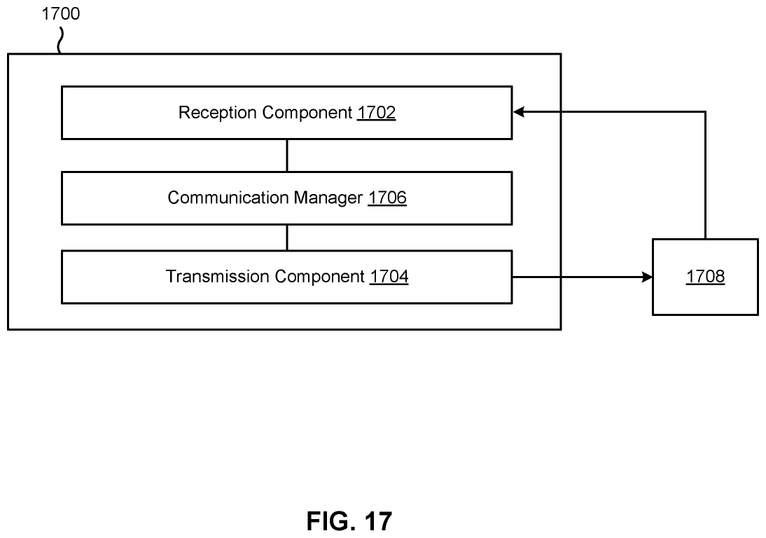

As shown in FIG. 15, in some aspects, process 1500 may include generating, for a relay UE, scheduling information that includes a first target and a first granted resource (block 1510). In some aspects, the network entity (e.g., using communication manager 1706, depicted in FIG. 17) may generate, for a relay UE, scheduling information that includes a first target and a first granted resource, as described above.

As further shown in FIG. 15, in some aspects, process 1500 may include transmitting the scheduling information to the relay UE using L1 signaling (block 1520). In some aspects, the network entity (e.g., using transmission component 1704 and/or communication manager 1706, depicted in FIG. 17) may transmit the scheduling information to the relay UE using L1 signaling, as described above.

Process 1500 may include additional aspects, such as any single aspect or any combination of aspects described below and/or in connection with one or more other processes described elsewhere herein.

In a first aspect, the first target includes an out-of-coverage (OOC) UE.

In a second aspect, alone or in combination with the first aspect, the scheduling information includes RL information that indicates a resource for transmission from the OOC UE to the relay UE.

In a third aspect, alone or in combination with one or more of the first and second aspects, the scheduling information includes RL information that indicates a resource for transmission from the relay UE to the network entity.

In a fourth aspect, alone or in combination with one or more of the first through third aspects, process 1500 includes transmitting data to the OOC UE via the relay UE using L1 signaling, and receiving feedback for the data from the OOC UE via the relay UE using L1 signaling.

In a fifth aspect, alone or in combination with one or more of the first through fourth aspects, process 1500 includes receiving a BSR from the relay UE using L1 signaling.

In a sixth aspect, alone or in combination with one or more of the first through fifth aspects, the scheduling information includes relay information for one or more other targets and one or more granted resources associated with the one or more other targets.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a UE, or a UE may include the apparatus 1600. In some aspects, the apparatus 1600 includes a reception component 1602, a transmission component 1604, and/or a communication manager 1606, which may be in communication with one another (in some aspects, via one or more buses and/or one or more other components). In some aspects, the communication manager 1606 is the communication manager 140 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 1-11. Additionally, or alternatively, the apparatus 1600 may be configured to perform one or more processes described herein, such as process 1200 of FIG. 12, process 1300 of FIG. 13, process 1400 of FIG. 14, or a combination thereof. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. In some aspects, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

The communication manager 1606 may support operations of the reception component 1602 and/or the transmission component 1604. In some aspects, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

In some aspects, the reception component 1602 may receive scheduling information for the first UE using L1 signaling, the scheduling information including a first target and a first granted resource for the first UE. The transmission component 1604 may transmit or receive a communication on a sidelink using L1 signaling based at least in part on the scheduling information.

In some aspects, the reception component 1602 may receive, using L1 signaling, data and scheduling information that indicates a first relay target and a first granted resource for the first UE. The communication manager 1606 may forward the data to the first relay target using L1 signaling based at least in part on the scheduling information.

The communication manager 1606 may hold the data before forwarding the data based at least in part on the scheduling information. The transmission component 1604 may transmit, to a second UE using L1 signaling, a sidelink grant for transmission of a BSR from the second UE to a network entity via the first UE. The reception component 1602 may receive the BSR using L1 signaling. The communication manager 1606 may forward the BSR to the network entity using L1 signaling.

In some aspects, the reception component 1602 may receive, using L1 signaling, scheduling information from a second UE that indicates a first relay target and a first granted resource for the first UE. The transmission component 1604 may transmit a communication using L1 signaling based at least in part on the scheduling information. The transmission component 1604 may transmit a sidelink grant to a third UE using L1 signaling based at least in part on the scheduling information.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a network entity, or a network entity may include the apparatus 1700. In some aspects, the apparatus 1700 includes a reception component 1702, a transmission component 1704, and/or a communication manager 1706, which may be in communication with one another (in some aspects, via one or more buses and/or one or more other components). In some aspects, the communication manager 1706 is the communication manager 150 described in connection with FIG. 1. As shown, the apparatus 1700 may communicate with another apparatus 1708, such as a UE or a network node (such as a CU, a DU, an RU, or a base station), using the reception component 1702 and the transmission component 1704.

In some aspects, the apparatus 1700 may be configured to perform one or more operations described herein in connection with FIGS. 1-11. Additionally, or alternatively, the apparatus 1700 may be configured to perform one or more processes described herein, such as process 1500 of FIG. 15. In some aspects, the apparatus 1700 and/or one or more components shown in FIG. 17 may include one or more components of the network entity described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. In some aspects, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1708. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the network entity described in connection with FIG. 2.

The transmission component 1704 may transmit communications, such as reference signals, control information, data communications, or a combination thereof, to the apparatus 1708. In some aspects, one or more other components of the apparatus 1700 may generate communications and may provide the generated communications to the transmission component 1704 for transmission to the apparatus 1708. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1708. In some aspects, the transmission component 1704 may include one or more antennas, a modem, a modulator, a transmit MIMO processor, a transmit processor, a controller/processor, a memory, or a combination thereof, of the network entity described in connection with FIG. 2. In some aspects, the transmission component 1704 may be co-located with the reception component 1702 in a transceiver.

The communication manager 1706 may support operations of the reception component 1702 and/or the transmission component 1704. In some aspects, the communication manager 1706 may receive information associated with configuring reception of communications by the reception component 1702 and/or transmission of communications by the transmission component 1704. Additionally, or alternatively, the communication manager 1706 may generate and/or provide control information to the reception component 1702 and/or the transmission component 1704 to control reception and/or transmission of communications.

The communication manager 1706 may generate, for a relay UE, scheduling information that includes a first target and a first granted resource. The transmission component 1704 may transmit the scheduling information to the relay UE using L1 signaling.

The transmission component 1704 may transmit data to the OOC UE via the relay UE using L1 signaling. The reception component 1702 may receive feedback for the data from the OOC UE via the relay UE using L1 signaling. The reception component 1702 may receive a BSR from the relay UE using L1 signaling.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a first user equipment (UE), comprising: receiving scheduling information for the first UE using Layer 1 (L1) signaling, the scheduling information including a first target and a first granted resource for the first UE; and transmitting or receiving a communication on a sidelink using L1 signaling based at least in part on the scheduling information.

Aspect 2: The method of Aspect 1, wherein the first UE is a relay UE, and wherein the scheduling information includes relay information for one or more other targets and one or more granted resources associated with the one or more other targets, and wherein the method includes transmitting the scheduling information using L1 signaling to a second UE that is one of the one or more targets.

Aspect 3: The method of Aspect 2, wherein receiving the scheduling information includes receiving the scheduling information from another relay UE using L1 signaling.

Aspect 4: The method of any of Aspects 1-3, wherein the scheduling information includes reverse link information that indicates a resource for transmission to a network entity.

Aspect 5: The method of any of Aspects 1-4, wherein receiving the scheduling information includes receiving the scheduling information from a network entity using L1 signaling.

Aspect 6: The method of any of Aspects 1-5, wherein receiving the scheduling information includes receiving the scheduling information from a relay UE using L1 signaling.

Aspect 7: A method of wireless communication performed by a first user equipment (UE), comprising: receiving, using Layer 1 (L1) signaling, data and scheduling information that indicates a first relay target and a first granted resource for the first UE; and forwarding the data to the first relay target using L1 signaling based at least in part on the scheduling information.

Aspect 8: The method of Aspect 7, further comprising holding the data before forwarding the data based at least in part on the scheduling information.

Aspect 9: The method of any of Aspects 7-8, wherein the scheduling information includes relay information for one or more other targets and one or more granted resources associated with the one or more other targets.

Aspect 10: The method of any of Aspects 7-9, wherein the scheduling information includes reverse link information that indicates a resource for transmission to a network entity, and wherein the method includes transmitting data or feedback to the network entity using L1 signaling based at least in part on the reverse link information.

Aspect 11: The method of any of Aspects 7-10, wherein the scheduling information includes reverse link information that indicates a relay information for transmission to a network entity via the first UE, and wherein the method includes transmitting a buffer status report to the network entity using L1 signaling based at least in part on the reverse link information.

Aspect 12: The method of any of Aspects 7-11, further comprising transmitting, to a second UE using L1 signaling, a sidelink grant for transmission of a buffer status report (BSR) from the second UE to a network entity via the first UE.

Aspect 13: The method of Aspect 12, further comprising: receiving the BSR using L1 signaling; and forwarding the BSR to the network entity using L1 signaling.

Aspect 14: A method of wireless communication performed by a first user equipment (UE), comprising: receiving, using Layer 1 (L1) signaling, scheduling information from a second UE that indicates a first relay target and a first granted resource for the first UE; and transmitting a communication using L1 signaling based at least in part on the scheduling information.

Aspect 15: The method of Aspect 14, wherein the first relay target is a third UE, and wherein transmitting the communication includes transmitting data to the third UE using L1 signaling.

Aspect 16: The method of Aspect 15, wherein the scheduling information includes reverse link information that indicates a resource for transmission to a network entity, and wherein the method includes: receiving feedback for the data from the third UE using L1 signaling; and forwarding the feedback to the network entity via the second UE using L1 signaling based at least in part on the reverse link information.

Aspect 17: The method of any of Aspects 14-16, further comprising transmitting a sidelink grant to a third UE using L1 signaling based at least in part on the scheduling information.

Aspect 18: The method of any of Aspects 14-17, wherein the scheduling information includes reverse link information that indicates a resource for transmission to a network entity, and wherein the method includes transmitting a buffer status report to a network entity using L1 signaling.

Aspect 19: A method of wireless communication performed by a network entity, comprising: generating, for a relay user equipment (UE), scheduling information that includes a first target and a first granted resource; and transmitting the scheduling information to the relay UE using Layer 1 (L1) signaling.

Aspect 20: The method of Aspect 19, wherein the first target includes an out-of-coverage (OOC) UE.

Aspect 21: The method of Aspect 20, wherein the scheduling information includes reverse link information that indicates a resource for transmission from the OOC UE to the relay UE.

Aspect 22: The method of Aspect 21, where the scheduling information includes reverse link information that indicates a resource for transmission from the relay UE to the network entity.

Aspect 23: The method of Aspect 22, further comprising: transmitting data to the OOC UE via the relay UE using L1 signaling; and receiving feedback for the data from the OOC UE via the relay UE using L1 signaling.

Aspect 24: The method of Aspect 22, further comprising receiving a buffer status report from the relay UE using L1 signaling.

Aspect 25: The method of any of Aspects 19-24, wherein the scheduling information includes relay information for one or more other targets and one or more granted resources associated with the one or more other targets.

Aspect 26: An apparatus for wireless communication at a device, comprising a processor: memory coupled with the processor; and instructions stored in the memory and executable by the processor to cause the apparatus to perform the method of one or more of Aspects 1-25.

Aspect 27: A device for wireless communication, comprising a memory and one or more processors coupled to the memory, the one or more processors configured to perform the method of one or more of Aspects 1-25.

Aspect 28: An apparatus for wireless communication, comprising at least one means for performing the method of one or more of Aspects 1-25.

Aspect 29: A non-transitory computer-readable medium storing code for wireless communication, the code comprising instructions executable by a processor to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, in some aspects, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first user equipment (UE) for wireless communication, comprising:
one or more memories; and
one or more processors, coupled to the one or more memories, individually or collectively configured to cause the first UE to:
receive scheduling information for the first UE using Layer 1 (L1) signaling, the scheduling information including a first target and a first granted resource for the first UE; and
transmit or receive a communication on a sidelink using L1 signaling based at least in part on the scheduling information.

2. The first UE of claim 1, wherein the first UE is a relay UE, and wherein the scheduling information includes relay information for one or more other targets and one or more granted resources associated with the one or more other targets, and wherein the one or more processors are individually or collectively configured to cause the first UE to transmit the scheduling information using L1 signaling to a second UE that is one of the one or more targets.

3. The first UE of claim 2, wherein the one or more processors, to receive the scheduling information, are individually or collectively configured to cause the first UE to receive the scheduling information from another relay UE using L1 signaling.

4. The first UE of claim 1, wherein the scheduling information includes reverse link information that indicates a resource for transmission to a network entity.

5. The first UE of claim 1, wherein the one or more processors, to receive the scheduling information, are individually or collectively configured to cause the first UE to receive the scheduling information from a network entity using L1 signaling.

6. The UE of claim 1, wherein the one or more processors, to receive the scheduling information, are individually or collectively configured to cause the first UE to receive the scheduling information from a relay UE using L1 signaling.

7. A first user equipment (UE) for wireless communication, comprising:
one or more memories; and
one or more processors, coupled to the one or more memories, individually or collectively configured to cause the first UE to:
receive, using Layer 1 (L1) signaling, data and scheduling information that indicates a first relay target and a first granted resource for the first UE; and
forward the data to the first relay target using L1 signaling based at least in part on the scheduling information.

8. The first UE of claim 7, wherein the one or more processors are individually or collectively configured to cause the first UE to hold the data before forwarding the data based at least in part on the scheduling information.

9. The first UE of claim 7, wherein the scheduling information includes relay information for one or more other targets and one or more granted resources associated with the one or more other targets.

10. The first UE of claim 7, wherein the scheduling information includes reverse link information that indicates a resource for transmission to a network entity, and wherein the one or more processors are individually or collectively configured to transmit data or feedback to the network entity using L1 signaling based at least in part on the reverse link information.

11. The first UE of claim 7, wherein the scheduling information includes reverse link information that indicates a relay information for transmission to a network entity via the first UE, and wherein the one or more processors are individually or collectively configured to transmit a buffer status report to the network entity using L1 signaling based at least in part on the reverse link information.

12. The UE of claim 7, wherein the one or more processors are individually or collectively configured to cause the first UE to transmit, to a second UE using L1 signaling, a sidelink grant for transmission of a buffer status report (BSR) from the second UE to a network entity via the first UE.

13. The first UE of claim 12, wherein the one or more processors are individually or collectively configured to cause the first UE to:
receive the BSR using L1 signaling; and
forward the BSR to the network entity using L1 signaling.

14. A first user equipment (UE) for wireless communication, comprising:
one or more memories; and
one or more processors, coupled to the one or more memories, individually or collectively configured to cause the first UE to:
receive, using Layer 1 (L1) signaling, scheduling information from a second UE that indicates a first relay target and a first granted resource for the first UE; and
transmit a communication using L1 signaling based at least in part on the scheduling information.

15. The first UE of claim 14, wherein the first relay target is a third UE, and wherein the one or more processors, to transmit the communication, are individually or collectively configured to transmit data to the third UE using L1 signaling.

16. The first UE of claim 15, wherein the scheduling information includes reverse link information that indicates a resource for transmission to a network entity, and wherein the one or more processors are individually or collectively configured to cause the first UE to:
receive feedback for the data from the third UE using L1 signaling; and
forward the feedback to the network entity via the second UE using L1 signaling based at least in part on the reverse link information.

17. The first UE of claim 14, wherein the one or more processors are individually or collectively configured to cause the first UE to transmit a sidelink grant to a third UE using L1 signaling based at least in part on the scheduling information.

18. The first UE of claim 14, wherein the scheduling information includes reverse link information that indicates a resource for transmission to a network entity, and wherein the one or more processors are individually or collectively configured to transmit a buffer status report to a network entity using L1 signaling.

19. A network entity for wireless communication, comprising:
one or more memories; and
one or more processors, coupled to the one or more memories, individually or collectively configured to cause the network entity to:
generate, for a relay user equipment (UE), scheduling information that includes a first target and a first granted resource; and
transmit the scheduling information to the relay UE using Layer 1 (L1) signaling.

20. The network entity of claim 19, wherein the first target includes an out-of-coverage (OOC) UE.

21. The network entity of claim 20, wherein the scheduling information includes reverse link information that indicates a resource for transmission from the OOC UE to the relay UE.

22. The network entity of claim 21, where the scheduling information includes reverse link information that indicates a resource for transmission from the relay UE to the network entity.

23. The network entity of claim 22, wherein the one or more processors are individually or collectively configured to cause the network entity to:
transmit data to the OOC UE via the relay UE using L1 signaling; and
receive feedback for the data from the OOC UE via the relay UE using L1 signaling.

24. The network entity of claim 22, wherein the one or more processors are individually or collectively configured to cause the network entity to receive a buffer status report from the relay UE using L1 signaling.

25. The network entity of claim 19, wherein the scheduling information includes relay information for one or more other targets and one or more granted resources associated with the one or more other targets.
